(19) United States
(12) Patent Application Publication
(10) Pub. No.: US 2026/0009748 A1
(43) Pub. Date: Jan. 8, 2026

(54) Optimized, Sparse Detector Arrays and Their Methods of Use

(71) Applicant: Rapiscan Holdings, Inc., Hawthorne, CA (US)

(72) Inventors: Mark Procter, Wilmslow (GB); Jasmin Burke, Stoke-on-Trent (GB)

(21) Appl. No.: 19/256,578

(22) Filed: Jul. 1, 2025

Related U.S. Application Data
(60) Provisional application No. 63/666,780, filed on Jul. 2, 2024.

(51) Int. Cl. G01N 23/083; G01N 23/04

(52) U.S. Cl. CPC G01N 23/083; G01N 23/04

(57) ABSTRACT

A detector assembly has a first detector array to detect low-energy photons and generate corresponding first scan image data. The first detector array has a first set of detector positions arranged in n rows and m columns. Alternate positions along each of the n rows and along each of the m columns are populated with detector elements. The detector assembly also comprises a second detector array to detect high-energy photons and generate corresponding second scan image data. The second detector array has a second set of detector positions arranged in N rows and M columns, and all detector positions in alternate rows are fully populated with second detector elements. A processor is configured to process the first and second scan image data, and the processing is modulated to optimize at least one of a set of image performance metrics.

### CROSS-REFERENCE

The present application relies on, for priority, U.S. Provisional Application No. 63/666,780, titled “Optimized, Sparse Detector Arrays and Their Methods of Use” and filed on Jul. 2, 2024, which is herein incorporated by reference in its entirety.

### FIELD

The present specification is related generally to the field of ionizing radiation-based scanning or imaging systems. More specifically, the present specification is related to detector arrays that are configured to be optimized for at least one image performance metric, including resolution, penetration, or wire detection.

### BACKGROUND

Ionizing radiation-based imaging systems are used in various applications ranging from medical imaging to scanning baggage, cargo and personnel for detection of contraband. Such imaging systems typically illuminate an object with ionizing radiation from a radiation source and detect radiation energy released from the object using one or more digital detector arrays.

Digital detector arrays may use scintillator-based detector elements that convert detected ionizing radiation into light energy. In turn, the light energy is subsequently converted into an electric charge using a photodetector array such as, for example, a plurality of photodiodes. Most crystal scintillators require high-purity chemicals and sometimes rare-earth metals that are fairly expensive.

The cost of manufacturing such digital detector arrays is therefore quite high thereby making implementation of an X-ray imaging system cost prohibitive in some applications.

Accordingly, there is need for detector arrays that use a reduced number of scintillator detector elements compared to traditional detectors fully populated with scintillator detector elements. There is also need for the “sparse” detector arrays that are configured to be optimized for at least one image performance metric, including resolution, penetration, or wire detection.

### SUMMARY

The following embodiments and aspects thereof are described and illustrated in conjunction with systems, tools and methods, which are meant to be exemplary and illustrative, and not limiting in scope. The present application discloses numerous embodiments.

In some embodiments, the present specification is directed towards an X-ray scanning system comprising: an X-ray radiation source configured to direct an X-ray beam toward a target; a detector assembly configured to receive X-ray radiation after the X-ray beam interacts with the target, wherein the detector assembly comprises: a first detector array positioned in a first plane to detect low-energy photons and generate corresponding first data indicative of a first scan image, wherein the first detector array has a first plurality of distinct spaces corresponding to an arca configured to receive one or more independent detector elements, the distinct spaces arranged in n rows and m columns, and wherein alternate positions along each of the n rows and along each of the m columns are populated with first detector elements while each of remaining ones of the first plurality of distinct spaces positioned between the first detector elements do not have an active detector element; a second detector array positioned in a second plane to detect high-energy photons and generate corresponding second data indicative of a second scan image, wherein the second detector array has a second plurality of distinct spaces arranged in N rows and M columns, wherein each of the second plurality of distinct spaces in a first row are populated with a second detector element, and wherein all of the second plurality of distinct spaces in a second row immediately adjacent to the first row do not have an active detector element; a processor and plurality of programmatic instructions configured to receive and process the first data and the second data and to generate a dual-energy scan image of the target, wherein the processor and the plurality of programmatic instructions are further adapted to optimize at least one of a plurality of image performance metrics in response to an input received from a user.

Optionally, the first plane is closer to the source and the second plane is farther from the source and positioned behind the first plane, and wherein the first and second planes are parallel to each other.

Optionally, a number of the second plurality of distinct spaces is less that a number of the first plurality of distinct spaces.

Optionally, a second area of each of the second detector elements on a side facing the high-energy photons is larger than a first area of each of the first detector elements on a side facing the low-energy photons. Still optionally, the second area is 1 to 4 times larger than the first area. Optionally, the plurality of image performance metrics comprises a horizontal resolution, a vertical resolution, an amount of penetration and wire detection.

Optionally, the processor and the plurality of programmatic instructions are further configured to determine a value for data corresponding to at least one of the first plurality of distinct spaces that does not have said active detector element by applying a function to data associated with at least two of the first detector elements positioned in the first plurality of distinct spaces located adjacent to said at least one of the first plurality of distinct spaces that does not have said active detector element.

Optionally, the processor and the plurality of programmatic instructions are further configured to optimize a horizontal resolution of the dual-energy scan image by applying said function to data associated with two of the first detector elements positioned in the first plurality of distinct spaces located above and below said at least one of the first plurality of distinct spaces that does not have said active detector element.

Optionally, the processor and the plurality of programmatic instructions are further configured to optimize a vertical resolution of the dual-energy scan image by applying said function to data associated with two of the first detector elements positioned in the first plurality of distinct spaces located to the right and left of said at least one of the first plurality of distinct spaces that does not have said active detector element.

Optionally, the processor and the plurality of programmatic instructions are further configured to optimize a degree of penetration or wire detection in the dual-energy scan image by applying said function to data associated with four of the first detector elements positioned in the first plurality of distinct spaces located to the left, to the right, above and below said at least one of the first plurality of distinct spaces that does not have said active detector element.

Optionally, a value for n and a value for N ranges from 1 to 1200. Optionally, a value for m and a value for M ranges from 1 to 20.

In some other embodiments, the present specification is directed towards a method of using an X-ray scanning system, wherein the scanning system has an X-ray radiation source to direct an X-ray beam onto a target for scanning and a detector assembly positioned to receive the X-ray radiation after the X-ray beam interacts with the target, wherein the detector assembly includes first and second detector arrays, the method comprising: receiving, at the detector assembly, the X-ray radiation after the X-ray beam interacts with the target; generating, by the first detector array, first scan image data corresponding to detection of predominantly low-energy photons, wherein the first detector array has a first plurality of distinct spaces corresponding to an arca configured to receive one or more independent detector elements, the distinct spaces arranged in n rows and m columns, and wherein only alternate positions along each of the n rows and along each of the m columns are populated with first detector elements while each of the remaining ones of the first plurality of distinct spaces positioned between the first detector elements do not have an active detector element; generating, by the second detector array, second scan image data corresponding to detection of predominantly high-energy photons, wherein the second detector array has a second plurality of distinct spaces arranged in N rows and M columns, wherein each of the second plurality of distinct spaces in a first row are populated with a second detector element, and wherein all of the second plurality of distinct spaces in a second row immediately adjacent to the first row do not have an active detector element; processing, by a processor, the first and second scan image data to generate a dual-energy scan image of the target, wherein the processing is modulated to optimize at least one of a plurality of image performance metrics in response to an input received from a user.

Optionally, the first and second detector arrays are respectively positioned in first and second planes such that the first plane is closer to the source and the second plane is farther from the source and positioned behind the first plane, and wherein the first and second planes are parallel to each other.

Optionally, a second number of the second plurality of distinct spaces is less than a first number of the first plurality of distinct spaces.

Optionally, a second area of a second facing side of each of the second detector elements is larger than a first area of a first radiation facing side of each of the first detector elements. Still optionally, the second area is 1 to 4 times larger than the first arca.

Optionally, the plurality of image performance metrics includes horizontal resolution, vertical resolution, an amount of penetration and wire detection.

Optionally, the method further comprises optimizing a horizontal resolution of the dual-energy scan image by applying said function to data associated with two of the first detector elements positioned in the first plurality of distinct spaces located above and below said at least one of the first plurality of distinct spaces that does not have said active detector element.

Optionally, the method further comprises optimizing a vertical resolution of the dual-energy scan image by applying said function to data associated with two of the first detector elements positioned in the first plurality of distinct spaces located to the right and left of said at least one of the first plurality of distinct spaces that does not have said active detector element.

Optionally, the method further comprises optimizing a degree of penetration or wire detection in the dual-energy scan image by applying said function to data associated with four of the first detector elements positioned in the first plurality of distinct spaces located to the left, to the right, above and below said at least one of the first plurality of distinct spaces that does not have said active detector element.

In some other embodiments, the present specification discloses an X-ray scanning system comprising: an X-ray radiation source to direct an X-ray beam onto a target for scanning; a detector assembly positioned to receive X-ray photons released from the target, wherein the detector assembly comprises: a first detector array positioned in a first plane to detect predominantly low-energy photons and generate corresponding first scan image data, wherein the first detector array has a first plurality of detector positions arranged in n rows and m columns, and wherein only alternate positions along each of the n rows and along each of the m columns are populated with first detector elements while the remaining unpopulated detector positions of the first plurality of detector positions are dead spaces; a second detector array positioned in a second plane to detect predominantly high-energy photons and generate corresponding second scan image data, wherein the second detector array has a second plurality of detector positions arranged in N rows and M columns, wherein all detector positions in alternate rows are fully populated with second detector elements while the remaining unpopulated detector positions of the second plurality of detector positions are dead spaces; and a processor configured to receive and process the first and second scan image data in order to generate a dual-energy scan image of the target, wherein the processing is modulated to optimize at least one of a plurality of image performance metrics.

Optionally, the first plane is closer to the source and the second plane is farther from the source and positioned behind the first plane, and the first and second planes are parallel to each other.

Optionally, a second number of the second plurality of detector positions is less that a first number of the first plurality of detector positions.

Optionally, a second area of a second facing side of each of the second detector elements is larger than a first area of a first radiation facing side of each of the first detector elements. Optionally, the second area is 1 to 4 times larger than the first area.

Optionally, the plurality of image performance metrics includes horizontal resolution, vertical resolution, penetration and wire detection.

Optionally, the processor is further configured to estimate scan data for each unpopulated detector position of the first plurality of detector positions in order to maximize horizontal resolution of the dual-energy scan image, wherein said estimation is based on the first scan image data captured in the first detector elements adjacent above and/or below of said each unpopulated detector position. Optionally, the processor is further configured to estimate scan data for each unpopulated detector position of the first plurality of detector positions in order to maximize vertical resolution of the dual-energy scan image, wherein said estimation is based on the first scan image data captured in the first detector elements adjacent left and/or right of said each unpopulated detector position. Optionally, the processor is further configured to estimate scan data for each unpopulated detector position of the first plurality of detector positions in order to optimize penetration and wire detection, wherein said estimation is based on the first scan image data captured in the first detector elements adjacent above, below, left and right of said each unpopulated detector position.

In still other embodiments, the present specification also discloses a method of using an X-ray scanning system, wherein the scanning system has an X-ray radiation source to direct an X-ray beam onto a target for scanning and a detector assembly positioned to receive X-ray photons released from the target, wherein the detector assembly includes first and second detector arrays, the method comprising: receiving, at the detector assembly, X-ray photons released from the target; generating, by the first detector array, first scan image data corresponding to detection of predominantly low-energy photons, wherein the first detector array has a first plurality of detector positions arranged in n rows and m columns, and wherein only alternate positions along each of the n rows and along each of the m columns are populated with first detector elements while the remaining unpopulated detector positions of the first plurality of detector positions are dead spaces; generating, by the second detector array, second scan image data corresponding to detection of predominantly high-energy photons, wherein the second detector array has a second plurality of detector positions is arranged in N rows and M columns, wherein all detector positions in alternate rows are fully populated with second detector elements while the remaining unpopulated detector positions of the second plurality of detector positions are dead spaces; processing, by a processor, the first and second scan image data in order to generate a dual-energy scan image of the target, wherein the processing is modulated to optimize at least one of a plurality of image performance metrics.

Optionally, the first and second detector arrays are respectively positioned in first and second planes such that the first plane is closer to the source and the second plane is farther from the source and positioned behind the first plane, and the first and second planes are parallel to each other.

Optionally, a second number of the second plurality of detector positions is less that a first number of the first plurality of detector positions.

Optionally, a second area of a second facing side of each of the second detector elements is larger than a first area of a first radiation facing side of each of the first detector elements. Optionally, the second area is 1 to 4 times larger than the first arca.

Optionally, the plurality of image performance metrics includes horizontal resolution, vertical resolution, penetration and wire detection.

Optionally, the method further comprises: estimating scan data for each unpopulated detector position of the first plurality of detector positions in order to maximize horizontal resolution of the dual-energy scan image, wherein said estimation is based on the first scan image data captured in the first detector elements adjacent above and/or below of said each unpopulated detector position. Optionally, the method further comprises estimating scan data for each unpopulated detector position of the first plurality of detector positions in order to maximize vertical resolution of the dual-energy scan image, wherein said estimation is based on the first scan image data captured in the first detector elements adjacent left and/or right of said each unpopulated detector position. Optionally, the method further comprises estimating scan data for each unpopulated detector position of the first plurality of detector positions in order to optimize penetration and wire detection, wherein said estimation is based on the first scan image data captured in the first detector elements adjacent above, below, left and right of said each unpopulated detector position.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a block diagram illustration of a scanning environment, in accordance with some embodiments of the present specification;

FIG. 2 shows a front view and a side view of a sparse detector array assembly, in accordance with some embodiments of the present specification;

FIG. 3 is a flowchart of a plurality of steps of a method of generating a dual-energy scan image of a target using the detector assembly of FIG. 2, in accordance with some embodiments of the present specification;

FIG. 4A is an illustration showing an input image subjected to a kernel-based technique for estimating data in a sparse detector, further showing an output image, in accordance with some embodiments of the present specification;

FIG. 4B is an illustration mapping an image to a kernel-based technique for estimating data in the sparse detector, in accordance with some embodiments of the present specification;

FIG. 5 is a block diagram of a single-layered sparse detector array assembly, in accordance with some embodiments of the present specification; and

FIG. 6 is a flowchart showing a plurality of steps of a method for generating a scan image of a target using the single-layered sparse detector array assembly of FIG. 5, in accordance with some embodiments of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phrascology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enable or cause the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

The term “module” or “engine” used in this disclosure may refer to computer logic utilized to provide a desired functionality, service or operation by programming or controlling a general purpose processor. Stated differently, in some embodiments, a module or engine implements a plurality of instructions or programmatic code to cause a general purpose processor to perform one or more functions. In various embodiments, a module or engine can be implemented in hardware, firmware, software or any combination thereof. The module or engine may be interchangeably used with unit, logic, logical block, component, or circuit, for example. The module or engine may be the minimum unit, or part thereof, which performs one or more particular functions.

It should be understood that each component described herein is configured to perform the functions that it is described to perform.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

In embodiments, the term “sparse” refers to a characteristic of a detector array in which the surface of the detector array is not fully covered by photosensors and, instead, comprises a plurality of empty spaces or voids upon which no photosensor is positioned, referred to as a dead space. A sparse detector array has at least 25% and up to 50% of its surface covered by dead space. In embodiments, it should be noted that the amount of “dead” space can be any amount that still achieves the objectives of the present specification and preferably, does not require a fully populated array but still obviates the need to recover data in non-adjacent pixels.

In the context of detector arrays described in this specification, “dead spaces” refer to specific positions or areas within the array that are not populated with active detector elements, such as scintillator-based detector elements or photodetectors. These unpopulated positions are intentionally left void of radiation-detecting components to reduce the overall density of detector elements in the array, thereby lowering manufacturing costs without significantly compromising imaging performance. In all configurations, dead spaces are deliberately introduced to achieve a “sparse” array design, where these areas neither actively detect nor contribute to signal generation but play a role in determining the overall layout and data estimation strategies for the detector array. For effective operation, these dead spaces are compensated for by computational techniques, such as interpolation or kernel-based data estimation, to estimate the radiation data that would otherwise be captured if these spaces were occupied by active detector elements.

In the context of the detector arrays described in this specification, “distinct spaces” refer to specific positions or areas within the array that are designed to accommodate active detector elements, such as scintillator-based detector elements or photodetectors. These positions are populated with components capable of detecting radiation, converting it into light energy (in the case of scintillators), and subsequently transforming the light signals into electrical signals for data processing. Distinct spaces are integral to the operation of the detector array and directly contribute to the generation of scan image data. The size, shape, and arrangement of distinct spaces can vary depending on the design of the detector array, with each distinct space being a functional unit in the imaging system.

### Overview

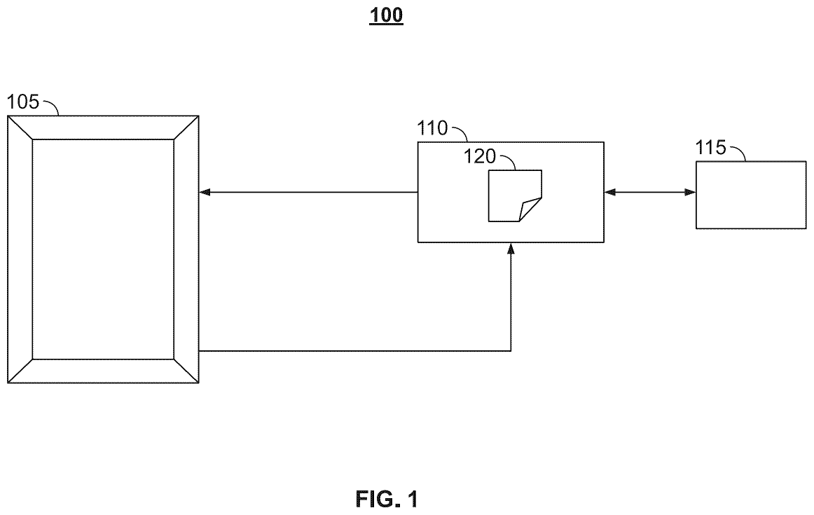

FIG. 1 is a block diagram illustration of a scanning environment 100, in accordance with some embodiments of the present specification. The scanning environment 100 comprises an X-ray scanning device 105 having at least one X-ray source and one or more distinct spaces, each distinct space corresponding to an area configured to receive an independent detector element. In some embodiments, a detector element comprises one or more sparse detector arrays. The at least one X-ray source is configured to direct an X-ray beam onto a target while the one or more sparse detector arrays are configured to detect X-ray radiation caused by an X-ray beam interacting with a target and therefore generate scan image data corresponding to the received and detected X-ray beam photons. The scan image data is received and processed by a processor 110 that is configured to generate at least one processed X-ray image of the target. The processed X-ray image is communicated to at least one user computing device 115 for display on an associated display or monitor.

In embodiments, the processor 110 is configured to implement at least one module or engine 120 directed towards performing various processing tasks such as, for example, data estimation, image reconstruction and correction. It should be appreciated that the functions of data estimation, image reconstruction and correction may either be integrated in a single module or engine (such as the module or engine 120) or, alternatively, may be distributed in multiple modules or engines. The processor 110 is also configured to receive user inputs from the computing device 115.

In some embodiments, each of the one or more distinct spaces includes an array of detector elements or pixels such as, for example, scintillation crystals and photodetectors connected or integrated into an integrated circuit. The scintillation crystal and photodetector arrays are integrated with the integrated circuit using conventional solid-state component manufacturing or bonding techniques. The scintillation crystals are formed from materials such as, but not limited to, Cadmium Tungstate, Bismuth Germanate, Cesium lodide, Sodium Iodide, for example, which are materials that are capable of generating light energy upon being excited with X-ray photons. As known to persons of ordinary skill in the art, the generated light signals are converted to proportional electrical signals by a corresponding photodetector. The analog electrical signals are digitized to generate scan image data for onward communication to the processor 110.

It should be understood by those of ordinary skill in the art that the X-ray scanning device 105 may, in various embodiments, include any ionizing radiation based imaging modality such as, but not limited to, a Radiography system, a CT (Computed Tomography) system, a Real-time Tomography (RTT) or stationary gantry system, or a PET (Positron Emission Tomography) system. It should be appreciated that while various aspects of the present specification have been described with reference to an X-ray based scanning or imaging device, these aspects are equally applicable to other ionizing radiation based imaging systems such as, for example, gamma radiation based systems.

### Checkerboard Detector Configuration

### Two-Layered Stacked Structure

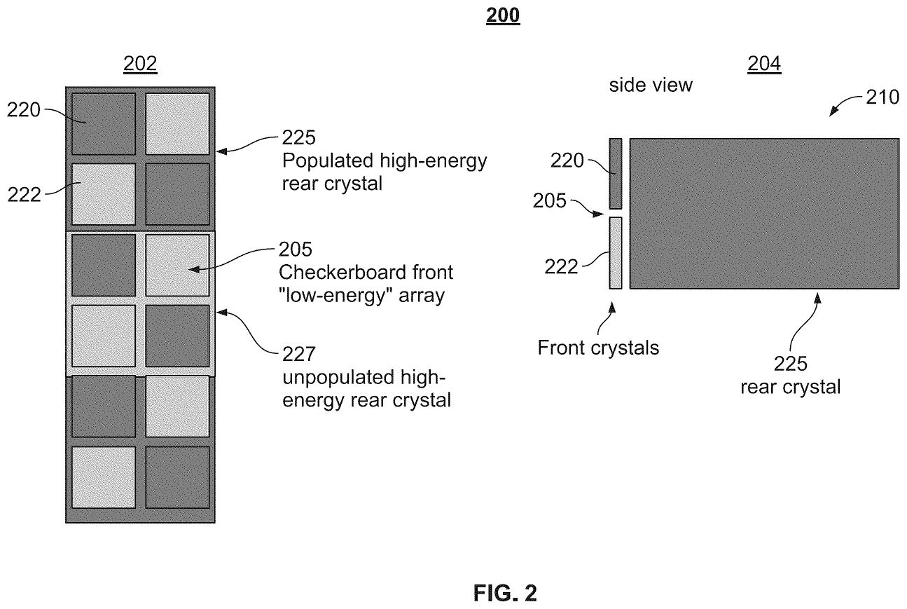

FIG. 2 shows a front view 202 and a portion of a side view 204 of a detector assembly 200, in accordance with some embodiments of the present specification. The detector assembly 200 (as shown in the Figures) is a two-layer stacked structure having a front detector array 205 closest to a source of ionizing radiation and a rear detector array 210 farther from the source. In some embodiments, the front detector array 205 and the rear detector array 210 are separated by a distance ranging from 1.6 mm to 50 mm. The distance of separation between the front detector array 205 and the rear detector array 210 is preferably zero, however a minimum distance is applicable due to the thickness of a Printed Circuit Board Assembly (PCBA). In one particular embodiment, the front detector array 205 and the rear detector array 210 are separated by a maximum distance of 20 mm. In some embodiments, the front detector array 205 is positioned in a first plane and the rear detector array 210 is positioned in a second plane, such that the first plane and second plane are substantially parallel to one another and the second plane is positioned behind the first plane when viewed along a direction of the received X-ray beam from the target object comprising X-ray photons impinging upon the detector assembly 200. The detector assembly 200 receives X-ray photons after having scanned an inspection space including the target object.

In embodiments, the front detector array 205 predominantly detects low-energy components of received X-ray photons while the rear detector array 210 predominantly detects high-energy components of the received X-ray photons.

In embodiments, the front detector array 205 includes n×m array of positions where n is a number of rows and m is a number of columns. In various embodiments, the number of rows n ranges from 1 to 1200 and the number of columns m ranges from 1 to 20, where the numbers are based on the actual application. In one embodiment, the number of rows n is 1200 and the number of columns m is 2. In embodiments, only a portion of the n×m positions is populated with distinct spaces comprising detector elements or pixels 220. In some embodiments, each independent detector element or pixel 220 is positioned in a distinct space. In some embodiments, the dimensions of a distinct space are 5 mm×5 mm for a front detector array. In some embodiments, only alternate positions along each of the n rows and along each of the m columns are distinct spaces with detector elements or pixels 220 (that is, no two consecutive distinct spaces, along a row or a column, has detector elements) thereby giving a checkerboard pattern of detector elements or pixels. Positions or area between the distinct spaces comprising detector elements, which are not populated with active detector elements 220 are broadly referred to herein as ‘dead spaces’ 222. In some embodiments, the dimensions of a dead space 222 are 5 mm×5 mm for a front detector array. In various embodiments, the dimensions of distinct spaces and dead spaces range from 1 mm×1 mm to 50 mm×50 mm for a front detector array. Herein, the term ‘position’ implies a cell, a block, or an element that combine to form rows and columns in a detector array. Each position is configured to accommodate an independent detector element. However, only selected positions are populated with distinct spaces comprising independent detector elements, while the remaining positions remain unpopulated (do not include active detector elements) also referred to herein as ‘dead spaces’. In some embodiments, the dead spaces 222 are populated with non-scintillating blocks of plastic, which in some embodiments, the non-scintillating block is an exact size of the dead space. In alternate embodiments, the dead spaces 222 are not populated with scintillating crystals.

A radiation facing side (that is the face or side that receives the X-ray photons) of each detector element or pixel 220, in the front detector array 205, has an area ‘a’. In some embodiments, the shape, size, and area of the radiation facing side of each detector element or pixel 220 is the same as that of each dead space 222 in the front detector array 205. In various embodiments, the area ‘a’ ranges from 1 to 100 mm².

The front view 202 of FIG. 2 shows a non-limiting embodiment, where the front detector array 205 has n=6 rows and m=2 columns. As shown, every alternate position along each row and column is populated with a distinct space with an independent detector element or pixel 220 while the remaining positions in each row and column are dead spaces 222 thereby creating a checkerboard pattern.

In some embodiments, compared to the front detector array 205, the rear detector array 210 is a larger and lower resolution detector that is typically used for high energy X-rays. Rear detector array also includes one or a plurality of distinct spaces comprising detector elements or pixels as well as dead spaces. In some embodiments, the rear detector array 210 includes N×M array of positions where N is a number of rows and M is a number of columns. In various embodiments, the number of rows N ranges from 1 to 1200 and the number of columns M ranges from 1 to 20, where the numbers are based on the actual application. In one embodiment, the number of rows N is 1200 and the number of columns M is 2. In some embodiments, each independent detector element or pixel is positioned in a distinct space. In various embodiments, the dimensions of distinct spaces and dead spaces range from 1 mm×1 mm to 50 mm×50 mm for a rear detector array. In some embodiments, the dimensions of a distinct space are 10 mm×10 mm for a rear detector array. In some embodiments, the dimensions of a dead space 222 are 10 mm×10 mm for a rear detector array. In some embodiments, N is less than n-that is, the total number of rows in the rear detector array 210 is less than the total number of rows in the front detector array 205. In some embodiments, M is less than m-that is, the total number of columns in the rear detector array 210 is less than the total number of columns in the front detector array 205. Consequently, in an embodiment where the rear detector array 210 has a similar distribution of distinct spaces and dead spaces as that of front detector array 205 (such as for example the checkerboard pattern illustrated in FIG. 2), then the total number of positions (N×M) in the rear detector array 210 are less than the total number of positions (n×m) in the front detector array 205.

In some embodiments, in rear detector array 210, every alternate position along each column is populated with a distinct space comprising an independent detector element or pixel 225 and, for every detector element or pixel 225 in a column, adjacent horizontal positions in each row are populated with additional distinct spaces with detector elements or pixels 225. Consequently, alternate rows of rear detector array 210 are fully populated with each position in each of these alternate rows comprising a distinct space with detector elements or pixels 225. Positions that do not include detector elements are referred to as dead spaces 227. Dead spaces 227 do not comprise active detector elements.

A radiation facing side (that is the face or side that receives the X-ray photons) of each detector element or pixel 225, in the rear detector array 210, has an area ‘A’. In some embodiments, the shape, size and area of the radiation facing side of each detector element or pixel 225 is the same as that of each dead space 227 in the rear detector array 210. In various embodiments, the area ‘A’ ranges from 1 to 100 mm².

In some embodiments, the area ‘A’ of the radiation facing side of each detector element or pixel 225 in the rear detector array 210 is larger than the area ‘a’ of each detector element or pixel 220 in the front detector array 205. In various embodiments, the area ‘A’ of the radiation facing side of each detector element or pixel 225 in the rear detector array 210 ranges from 1 to 4 times the area ‘a’ of each detector element or pixel 220 in the front detector array 205.

In some embodiments, the radiation facing side of each detector element or pixel 225 and of each dead space 227 of the rear detector array 210 has a height approximately equal to a height ranging from 1 to 4 rows of the front detector array 205 and a width approximately equal to a width ranging from 1 to 4 columns of the front detector array 210.

The front view 202 of FIG. 2 shows a non-limiting embodiment, where the rear detector array 210 has n=3 rows and m=1 column. As shown, every alternate position along the column is populated with a distinct space comprising a detector element or pixel 225 while the remaining positions are dead spaces 227. Consequently, alternate rows are fully populated with detector elements or pixels 225 whereas the remaining alternate rows have dead spaces 227.

Also, in this embodiment, the area ‘A’ of a radiation facing side of each detector element or pixel 225 in the rear detector array 210 is approximately 4 times the area ‘a’ of each detector element or pixel 220 in the front detector array 205.

As shown in side view 204, the radiation facing side of each detector element or pixel 225 and dead space 227 has a height approximately equal to a height of two rows of the front detector array 205 and a width approximately equal to a width of two columns of the front detector array 210.

Table 1 illustrates exemplary values of rows and columns for the first and second detector arrays, and their exemplary dimensions, which are used in various embodiments of the present specification:

TABLE 1

| | | Dimensions 1 | | Dimensions 2 | | Dimensions 3 |
|---|---|---|---|---|---|---|
| | | of Each | | of Each | | of Each |
| | | Distinct Space | | Distinct Space | | Distinct Space |
| Row/Column | Value 1 | (mm) | Value 2 | (mm) | Value 3 | (mm) |
| n | 6 | 5 | 100 | 5 | 1000 | 3 |
| m | 2 | 5 | 6 | 5 | 2 | 3 |
| N | 3 | 20 | 50 | 5 to 20 | 500 | 3 to 12 |
| M | 1 | 20 | 3 | 5 to 20 | 1 | 3 to 12 |

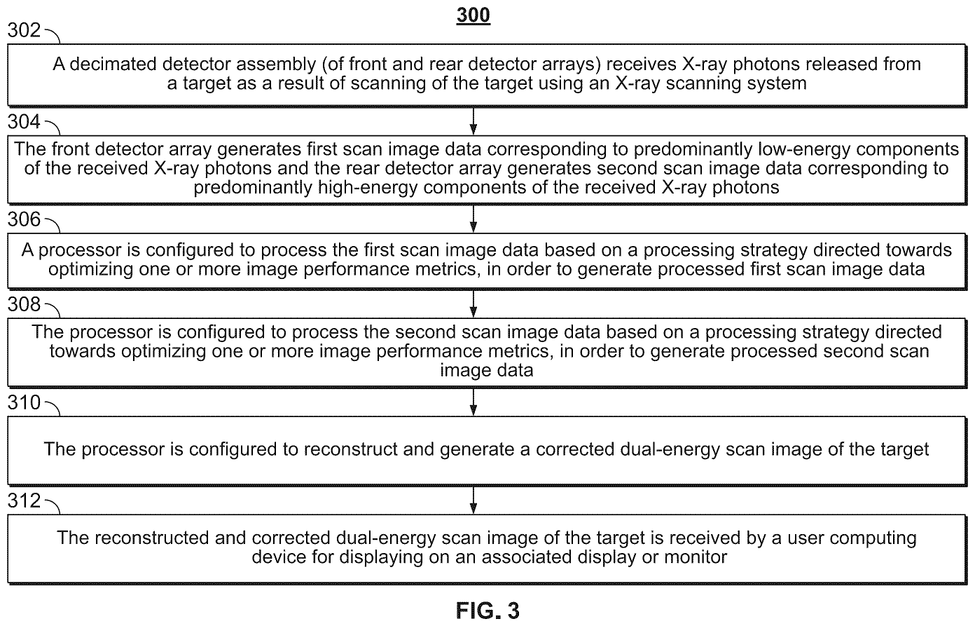

FIG. 3 is a flowchart of a plurality of steps of a method 300 of generating a dual-energy scan image of a target using the detector assembly 200, in accordance with some embodiments of the present specification. Referring now to FIGS. 1, 2 and 3, at step 302, the sparse detector assembly 200 receives X-ray photons released from the target as a result of scanning of the target using the X-ray scanning system 105.

At step 304, the front detector array 205 generates first scan image data corresponding to predominantly low-energy components of the received X-ray photons and the rear detector array 210 generates second scan image data corresponding to predominantly high-energy components of the received X-ray photons. In some embodiments, the front detector array 205 and rear detector array 210 each have scintillation crystals coupled with photodetectors or light sensors as detector elements which generate light signals corresponding to incident X-ray photons and convert light signals to proportional electrical signals that are further converted to computer-readable (or digital) first and second scan image data.

At step 306, the processor 110 processes (and is configured to do so) the first scan image data based on a processing strategy directed towards optimizing one or more image performance metrics, in order to generate processed first scan image data. In embodiments, processing may include data estimation followed by image reconstruction and/or image correction. Persons of ordinary skill in the art would appreciate that some of the most valued image performance metrics include data estimation pertaining imaging performance of the X-ray systems utilized for inspection of target objects. The imaging performance is determined based on X-ray beam penetration, image resolution (horizontal, vertical) of the detected X-ray beam, and wire detection. Herein, penetration refers to the ability of X-rays to pass through matter. Penetration is for materials requiring further inspection in high attenuation regions, where the large attenuation limits the ability to achieve high resolution anyway, in which case only bulky items can be identified. The amount of penetration varies depending on the material and the energy of the X-rays. X-ray imaging sometimes is used to detect and characterize wires in various applications, including semiconductor fabrication, cable inspection, and wire harness manufacturing. It allows for the identification of defects like wire breakage, poor bonding, and shorts within these systems. Wire detection could be for any thin, low intensity object that is not rigidly horizontal or vertical in nature and that requires further scrutiny.

In some embodiments, a first processing strategy is directed towards optimizing horizontal resolution image performance. Optimization refers to maximizing the ability to recover the optimal performance for a certain metric, which in this example is horizontal resolution. Resolution is just one example of a metric that may be optimized-in embodiments, different metrics or parameters may be optimized. Reconstructing images for the vertical metric, by placing a higher focus on averaging between vertically adjacent pixels, instead of horizontal, has an impact on the ability to maximize performance for horizontal resolution metric, and vice versa. Accordingly, in the case of optimizing horizontal resolution image performance, the processor 110 is configured to implement a data estimation algorithm that uses scan image data captured in the populated positions (or distinct spaces including the detector elements or pixels) that are adjacent above and/or below the unpopulated positions (that is, the dead spaces or positions not having active detector elements) to estimate an amount of radiation or scan data that would have been detected in the unpopulated positions if the unpopulated positions had been populated with detector elements or pixels. In various embodiments, data estimation is performed using interpolation, analytical and/or iterative techniques known to those skilled in the art.

In some embodiments, a second processing strategy is directed towards optimizing vertical resolution image performance. Accordingly, the processor 110 is configured to implement a data estimation algorithm that uses scan image data captured in the populated positions (or distinct spaces including the detector elements or pixels) that are adjacent left and/or right of the unpopulated positions (that is, the dead spaces or positions not having active detector elements) to estimate an amount of radiation or scan data that would have been detected in the unpopulated positions if the unpopulated positions had been populated with detector elements or pixels. In various embodiments, data estimation is performed using interpolation, analytical and/or iterative techniques known to those skilled in the art.

In some embodiments, a third processing strategy is directed towards optimizing both estimation of penetration and wire detection. Accordingly, in an embodiment, the processor 110 is configured to implement a data estimation algorithm that uses scan image data captured in all four populated detector positions (or distinct spaces including the detector elements or pixels) that are adjacent left, right, above and below of the unpopulated positions (that is, the dead spaces or positions not having active detector elements) to estimate an amount of radiation or scan data that would have been detected in the unpopulated positions had been populated with detector elements or pixels. Thus, in an embodiment, data estimation is based on an average of the scan image data captured in all four populated detector positions that are adjacent left, right, top and bottom of an unpopulated position. Given that the penetration is large area, and that the wire detection covers a larger 2D extent or surface, the ID resolution may be less optimized as a consequence of application of the third processing strategy in which penetration and wire detection is optimized.

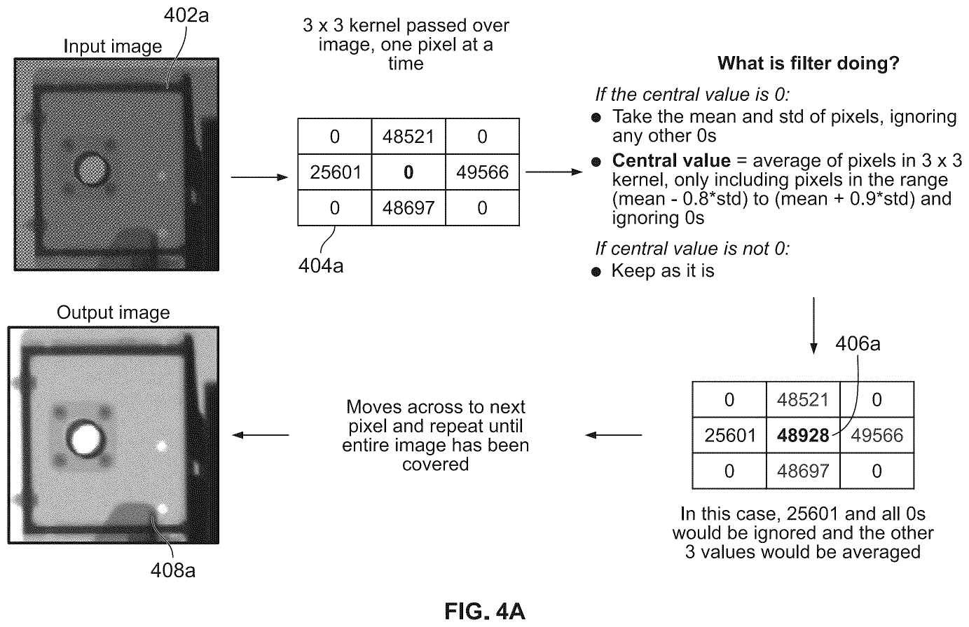

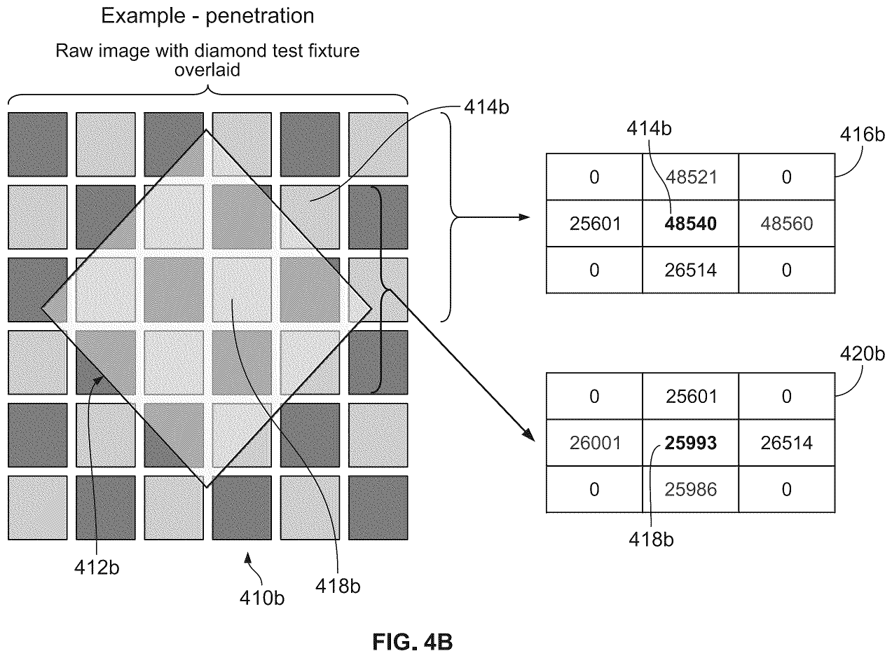

In some embodiments, data estimation (in the first, second and third processing strategies described above) is executed using a kernel-based technique as illustrated in FIGS. 4A and 4B. The kernel-based technique illustrated herein, is one embodiment of a method for data estimation. In other embodiments, other forms of data estimation techniques can be used, which may include and are not limited to model-based reconstruction, deep learning models, Bayesian estimation, and Fourier-based techniques. As shown in FIG. 4A, and as implemented by processor 110, module or engine 120 is configured such that it receives, as input, scan image data 402a. The module or engine 120 is also configured to pass a 3×3 kernel 404a over the scan image data 402a—one pixel at a time. Upon passing kernel 404a over a pixel, if a central value 406a is zero then, the module or engine 120 is configured to a) calculate the mean and standard deviation of the pixels (covered by the kernel 404a) by ignoring any other zeros, and b) determine the central value 406a by calculating an average of pixels in the 3×3 kernel 404a, only including pixels in the range of {mean−0.8×standard deviation} to {mean+0.9×standard deviation} and ignoring the zeros. In the current case of the kernel 404a, as illustrated in FIG. 4A, the value 25601 and all zeros are ignored and the remaining three values are averaged to arrive at the central value 406a (that is, (48521+49566 +48697)/3=48928). However, if the central value 406a is not zero, then the central value 406a is kept as is (that is, unchanged). The kernel 404a is moved across to subsequent pixels and the above process of determining the central value 406a is repeated until the entire scan image data 402a is covered. As a result of the kernel-based data estimation process, a processed scan image data 408a is output by the processor 110.

FIG. 4B is an illustration mapping the above kernel-based technique to raw scan image data 410b with an overlaid diamond test fixture 412b. As discussed earlier, upon passing a kernel over a pixel, if a central value is zero then, the module or engine 120 is configured to a) calculate the mean and standard deviation of the pixels (covered by the kernel) by ignoring any other zeros, and b) determine the central value by calculating an average of pixels in the 3×3 kernel, only including pixels in the range {mean−0.8×standard deviation} to {mean+0.9×standard deviation} and ignoring the zeros. Accordingly, for estimating pixel data corresponding to the central value 414b, in the 3×3 kernel 416b, the values 25601, 26514 and all zeros are ignored and the other two values are averaged (that is, (48521+48560)/2=48540). Similarly, for estimating pixel data corresponding to the central value 418b, in the 3×3 kernel 420b, the values 25601, 26514 and all zeros are ignored and the other two values are averaged (that is, (26001+25986)/2=25993).

It should be appreciated that penetration benefits from an average of all nearest neighbors. Both penetration and wire detection also benefit from incorporating a first pass edge detection algorithm which limits certain pixels from inclusion in the averaging if a) an edge of the diamond test piece is encountered or (ii) there are different wire gauges which will result in varying amounts of pixel coverage in the image. In one example, an edge detection filter or kernel may be the Sobel filter. The Sobel filter uses two 3×3 kernels to detect edges in both the horizontal and vertical directions. The Sobel filter emphasizes regions of high spatial frequency, which correspond to edges. In some cases, the horizontal kernel is:

$$[ \begin{matrix}- 1 & 0 & 1 \\ - 2 & 0 & 2 \\ - 1 & 0 & 1\end{matrix} ]$$

and the vertical kernel is:

$$[ \begin{matrix}- 1 & - 2 & - 1 \\ 0 & 0 & 0 \\ 1 & 2 & 1\end{matrix} ]$$

The Sobel filter kernels, when convolved with an image, generate directional gradients that accentuate edge features. These gradients are combined into a magnitude map, creating a unified edge-enhanced image where edges are intensified. This process ensures reconstruction filters can effectively prioritize edge structures when interpolating missing pixels near boundaries. Alternative Sobel configurations may target angled edges, such as those resembling penetration diamonds in specialized contexts.

In some embodiments, thresholds are applied for any adjacent detector element or pixel prior to its incorporation into the average. As a non-limiting example, a penetration performance test fixture requires identification of a diamond steel plate against a backdrop of a plurality of steel clutter plates. Scanning of diamond edges, of the diamond steel plate, will result in detector elements or pixels populated to the left of a dead space or blank spot, differing from those to the right at the diamond edges. In this case, comparing scan image data of adjacent pixels to the left and bottom of a dead space, with those to the right and top may reveal a diamond edge in an X-ray image, reflected by a step change in detector signals. In this instance, a decision can be taken whether to use just the two pixels to the left and bottom or the two pixels to the right and top as an average in populating the middle dead space or cell.

In some embodiments, the module or engine 120 is configured to generate at least one graphical user interface (GUI) for display to an operator. The GUI may support the operator to choose one of the first processing, second processing, or third processing strategies by actuating a virtual icon or button, from a plurality of virtual icons or buttons, displayed within the GUI. As a non-limiting example, a high-energy scan image is displayed within the GUI to the operator, and is calibrated to 16 bits across the entire dynamic intensity range. This scan image cannot reveal a penetration test object on its own, as the contrast level is within the lowest bits of the scan image, with a signal deviation 3 times the actual signal. To reveal the penetration phantom, application of a filter chain (averaging, median filtering, Gaussian blurring, and so forth) is required. This is implemented with the operator selecting a region, in the scan image, and clicking on a “penetration” icon or button from the plurality of virtual icons or buttons. Clicking the “penetration” icon or button causes the module or engine 120 to implement the third processing strategy. In this instance, the image presented to the operator would most likely be that of the averaging of all nearest neighbors.

Subsequently, the operator may highlight a region, in the scan image, of the horizontal resolution test fixture, and then click on a “horizontal resolution” icon or button from the plurality of virtual icons or buttons. Clicking the “horizontal resolution” icon or button causes the module or engine 120 to implement the first processing strategy resulting in the application of a specific filter to the region and display of the region with maximum horizontal resolution reconstruction. Similarly, clicking a “vertical resolution” icon or button causes the module or engine 120 to implement the second processing strategy for displaying a selected region of the scan image with maximum vertical resolution reconstruction. Thus, the process would be identical for all image performance metrics.

Referring again to FIG. 3, at step 308, the processor 110 processes the second scan image data based on a processing strategy directed towards optimizing one or more image performance metrics, as it is configured to do, in order to generate processed second scan image data. In some embodiments, the processing strategy includes determining a simple average of the pixel values above and below an area between distinct spaces that do not have an active detector element (dead space) in order to estimate data for the detector position corresponding to the area.

At step 310, the configured processor 110 reconstructs and generates a corrected dual-energy scan image of the target. In some embodiments, the processor 110 uses the first and second scan image data, including data estimated for dead spaces in the front and rear detector arrays 205, 210 to perform image reconstruction. Alternatively, in some embodiments, the processor 110 uses the first and second scan image data to perform image reconstruction and thereafter uses the data estimated for dead spaces in the front and rear detector arrays 205, 210 to apply corrections to the reconstructed image.

At step 312, the reconstructed and corrected dual-energy scan image of the target is received by the user computing device 115 for displaying on an associated display or monitor.

### Single-Layered Structure

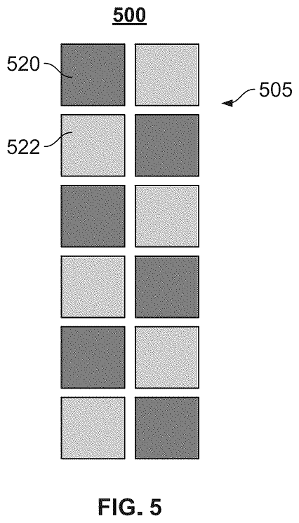

FIG. 5 is a block diagram representation of a detector array assembly 500. The detector assembly 500 (as shown in the Figure) is a single-layer structure including a detector array 505. The detector array assembly 500 is configured to receive X-ray photons after an inspection space is scanned with an X-ray source.

In embodiments, the detector array 505 includes n×m array of positions where n is a number of rows and m is a number of columns. In embodiments, only a portion of the n×m positions intended for detector elements is populated with distinct spaces comprising detector elements or pixels 520. In some embodiments, only alternate positions along each of the n rows and along each of the m columns are populated with detector elements or pixels 520 (that is, no two consecutive positions, along a row or a column, has detector elements) thereby approximating a checkerboard pattern of detector elements or pixels. Positions that are not populated with detector elements are referred to as dead spaces 522.

A radiation facing side (that is the face or side that receives the X-ray photons) of each detector element or pixel 520, in the detector array 505, has an area ‘a’. In some embodiments, the shape, size, and area of the radiation facing side of each detector element or pixel 520 is the same as that of each dead space 522 in the front detector array 505. In various embodiments, the area ‘a’ ranges from 1 to 100 mm².

In a non-limiting embodiment of FIG. 5, the detector assembly 500 has n=6 rows and m=2 columns. As shown, every alternate detector position along each row and column is populated with a detector element or pixel 520 while the remaining positions are dead spaces 522 thereby creating a checkerboard pattern.

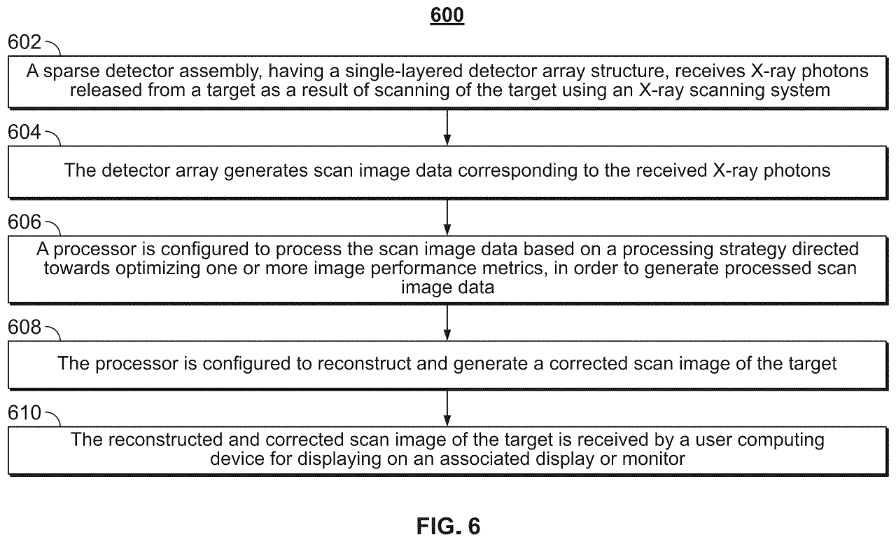

FIG. 6 is a flowchart showing a plurality of steps of a method 600 for generating a scan image of a target using the single-layered sparse detector array assembly 500 of FIG. 5, in accordance with some embodiments of the present specification. Referring now to FIGS. 1, 5 and 6, at step 602, the sparse detector assembly 500 detects X-ray radiation caused by an X-ray beam interacting with the target using the X-ray scanning system 105.

At step 604, the detector array 505 generates scan image data corresponding to the received X-ray photons. In some embodiments, the detector array 505 has scintillation crystals coupled with photodetectors or light sensors as detector elements which generate light signals corresponding to incident X-ray photons in the received X-ray beam reflected by the target object, and convert light signals to proportional electrical signals that are further converted to a computer-readable (or digital) scan image data.

It should be noted herein that processor 110 is configured to perform the functions, implementations, and processes described below.

At step 606, the processor 110 processes the scan image data based on a processing strategy directed towards optimizing one or more image performance metrics, to generate processed scan image data. In embodiments, processing may include data estimation followed by image reconstruction and/or image correction. Persons of ordinary skill in the art would appreciate that some of the most valued image performance metrics include penetration, resolution (horizontal, vertical) and wire detection.

In some embodiments, a first processing strategy is directed towards optimizing horizontal resolution image performance. Accordingly, the processor 110 implements a data estimation algorithm that uses scan image data captured in the populated detector positions (that is, the detector elements or pixels) that are adjacent above and/or below the unpopulated detector positions (that is, the dead spaces) to estimate an amount of radiation or scan data that would have been detected in the unpopulated detector positions or dead spaces if the unpopulated detector positions had been populated with detector elements or pixels. In some embodiments, data estimation is performed using interpolation, analytical and/or iterative techniques known to those skilled in the art.

In some embodiments, a second processing strategy is directed towards optimizing vertical resolution image performance. Accordingly, the processor 110 implements a data estimation algorithm that uses scan image data captured in the populated detector positions (that is, the detector elements or pixels) that are adjacent left and/or right of the unpopulated detector positions (that is, the dead spaces) to estimate an amount of radiation or scan data that would have been detected in the unpopulated detector positions or dead spaces had been populated with detector elements or pixels. In some embodiments, data estimation is performed using interpolation, analytical and/or iterative techniques known to those skilled in the art.

In some embodiments, a third processing strategy is directed towards optimizing both penetration and wire detection. Accordingly, in one embodiment, the processor 110 implements a data estimation algorithm that uses scan image data captured in all four populated detector positions (that is, the detector elements or pixels) that are adjacent left, right, above and below of the unpopulated detector positions (that is, the dead spaces) to estimate an amount of radiation or scan data that would have been detected in the unpopulated detector positions or dead spaces if the unpopulated detector positions had been populated with detector elements or pixels. In an embodiment, data estimation is based on an average of the scan image data captured in all four populated detector positions that are adjacent left, right, top and bottom of an unpopulated detector position. Given that the penetration is large area, and that the wire detection covers a larger 2D extent or surface, the 1D resolution may be less optimized as a consequence of application of the third processing strategy in which penetration and wire detection is optimized.

In some embodiments, data estimation (in the first, second and third processing strategies) is performed using a kernel-based technique already described above, in this specification, with reference to FIGS. 4A and 4B.

In some embodiments, the module or engine 120 is configured to generate at least one graphical user interface (GUI) for display to an operator. Using the GU, the operator may choose one of the first processing, second processing, or third processing strategies by actuating a virtual icon or button, from a plurality of virtual icons or buttons, displayed within the GUI. As a non-limiting example, a high-energy scan image is displayed within the GUI to the operator, and is calibrated to 16 bits across the entire dynamic intensity range. This scan image cannot reveal a penetration test object on its own, as the contrast level is within the lowest bits of the scan image, with a signal deviation 3 times the actual signal. To reveal the penetration phantom, application of a filter chain (averaging, median filtering, Gaussian blurring, and so forth) is required. This is implemented with the operator selecting a region, in the scan image, and clicking on a “penetration” icon or button from the plurality of virtual icons or buttons. Clicking the “penetration” icon or button causes the module or engine 120 to implement the third processing strategy. In this instance, the image presented to the operator would most likely be that of the averaging of all nearest neighbors.

Subsequently, the operator may highlight a region, in the scan image, of the horizontal resolution test fixture, and then click on a “horizontal resolution” icon or button from the plurality of virtual icons or buttons. Clicking the “horizontal resolution” icon or button causes the module or engine 120 to implement the first processing strategy resulting in the application of a specific filter to the region and display of the region with maximum horizontal resolution reconstruction. Similarly, clicking a “vertical resolution” icon or button causes the module or engine 120 to implement the second processing strategy for displaying a selected region of the scan image with maximum vertical resolution reconstruction. Thus, the process would be identical for all image performance metrics. The operators may use their training to determine which filters to use while observing each portion of an image. In some cases, where the choice of an applicable filter is unclear, the operator may elect to optimize both the horizontal resolution metric as well as the vertical resolution metric to help with adjudication.

At step 608, the configured processor 110 reconstructs and generates a corrected scan image of the target. In some embodiments, the processor 110 uses the scan image data, including data estimated for dead spaces in the detector array 505 to perform image reconstruction. Alternatively, in some embodiments, the processor 110 uses the scan image data to perform image reconstruction and thereafter uses the data estimated for dead spaces in the detector array 505 to apply corrections to the reconstructed image.

At step 610, the reconstructed and corrected scan image of the target is received by the user computing device 115 for displaying on an associated display or monitor.

It should be appreciated that the configurations of each of the detector assemblies 200 and 500 of FIGS. 2 and 5, respectively, may be extended to wider arrays and not just a two-column array. For example, in some embodiments, the non-checkerboard detector assembly 500 may be a six columns wide high speed rail scanner array in which six individual detector pixels are populated across the full width of the array (that is, m=6 columns).

Also, the detector assemblies 200 and 500 of FIGS. 2 and 5, respectively, result in a reduction of detector element or pixel population by a factor of two thereby reducing the overall cost of the detector, and depending upon the approach taken-maintaining performance versus suffering a slight reduction in performance for one particular metric.

The above examples are merely illustrative of the many applications of the systems and methods of the present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. An X-ray scanning system comprising:
an X-ray radiation source configured to direct an X-ray beam toward a target;
a detector assembly configured to receive X-ray radiation after the X-ray beam interacts with the target, wherein the detector assembly comprises:
a first detector array positioned in a first plane to detect low-energy photons and generate corresponding first data indicative of a first scan image, wherein the first detector array has a first plurality of distinct spaces corresponding to an area configured to receive one or more independent detector elements, the distinct spaces arranged in n rows and m columns, and wherein alternate positions along each of the n rows and along each of the m columns are populated with first detector elements while each of remaining ones of the first plurality of distinct spaces positioned between the first detector elements do not have an active detector element;
a second detector array positioned in a second plane to detect high-energy photons and generate corresponding second data indicative of a second scan image, wherein the second detector array has a second plurality of distinct spaces arranged in N rows and M columns, wherein each of the second plurality of distinct spaces in a first row are populated with a second detector element, and wherein all of the second plurality of distinct spaces in a second row immediately adjacent to the first row do not have an active detector element;
a processor and plurality of programmatic instructions configured to receive and process the first data and the second data and to generate a dual-energy scan image of the target, wherein the processor and the plurality of programmatic instructions are further adapted to optimize at least one of a plurality of image performance metrics in response to an input received from a user.

2. The X-ray scanning system of claim 1, wherein the first plane is closer to the source and the second plane is farther from the source and positioned behind the first plane, and wherein the first and second planes are parallel to each other.

3. The X-ray scanning system of claim 1, wherein a number of the second plurality of distinct spaces is less than a number of the first plurality of distinct spaces.

4. The X-ray scanning system of claim 1, wherein a second area of each of the second detector elements on a side facing the high-energy photons is larger than a first area of each of the first detector elements on a side facing the low-energy photons.

5. The X-ray scanning system of claim 4, wherein the second area is 1 to 4 times larger than the first area.

6. The X-ray scanning system of claim 1, wherein the plurality of image performance metrics comprises a horizontal resolution, a vertical resolution, an amount of penetration and wire detection.

7. The X-ray scanning system of claim 1, wherein the processor and the plurality of programmatic instructions are further configured to determine a value for data corresponding to at least one of the first plurality of distinct spaces that does not have said active detector element by applying a function to data associated with at least two of the first detector elements positioned in the first plurality of distinct spaces located adjacent to said at least one of the first plurality of distinct spaces that does not have said active detector element.

8. The X-ray scanning system of claim 7, wherein the processor and the plurality of programmatic instructions are further configured to optimize a horizontal resolution of the dual-energy scan image by applying said function to data associated with two of the first detector elements positioned in the first plurality of distinct spaces located above and below said at least one of the first plurality of distinct spaces that does not have said active detector element.

9. The X-ray scanning system of claim 7, wherein the processor and the plurality of programmatic instructions are further configured to optimize a vertical resolution of the dual-energy scan image by applying said function to data associated with two of the first detector elements positioned in the first plurality of distinct spaces located to the right and left of said at least one of the first plurality of distinct spaces that does not have said active detector element.

10. The X-ray scanning system of claim 7, wherein the processor and the plurality of programmatic instructions are further configured to optimize a degree of penetration or wire detection in the dual-energy scan image by applying said function to data associated with four of the first detector elements positioned in the first plurality of distinct spaces located to the left, to the right, above and below said at least one of the first plurality of distinct spaces that does not have said active detector element.

11. The X-ray scanning system of claim 1, wherein a value for n and a value for N ranges from 1 to 1200.

12. The X-ray scanning system of claim 1, wherein a value for m and a value for M ranges from 1 to 20.

13. A method of using an X-ray scanning system, wherein the scanning system has an X-ray radiation source to direct an X-ray beam onto a target for scanning and a detector assembly positioned to receive the X-ray radiation after the X-ray beam interacts with the target, wherein the detector assembly includes first and second detector arrays, the method comprising:
receiving, at the detector assembly, the X-ray radiation after the X-ray beam interacts with the target;
generating, by the first detector array, first scan image data corresponding to detection of predominantly low-energy photons, wherein the first detector array has a first plurality of distinct spaces corresponding to an area configured to receive one or more independent detector elements, the distinct spaces arranged in n rows and m columns, and wherein only alternate positions along each of the n rows and along each of the m columns are populated with first detector elements while each of the remaining ones of the first plurality of distinct spaces positioned between the first detector elements do not have an active detector element;
generating, by the second detector array, second scan image data corresponding to detection of predominantly high-energy photons, wherein the second detector array has a second plurality of distinct spaces arranged in N rows and M columns, wherein each of the second plurality of distinct spaces in a first row are populated with a second detector element, and wherein all of the second plurality of distinct spaces in a second row immediately adjacent to the first row do not have an active detector element;
processing, by a processor, the first and second scan image data to generate a dual-energy scan image of the target, wherein the processing is modulated to optimize at least one of a plurality of image performance metrics in response to an input received from a user.

14. The method of claim 13, wherein the first and second detector arrays are respectively positioned in first and second planes such that the first plane is closer to the source and the second plane is farther from the source and positioned behind the first plane, and wherein the first and second planes are parallel to each other.

15. The method of claim 13, wherein a second number of the second plurality of distinct spaces is less than a first number of the first plurality of distinct spaces.

16. The method of claim 13, wherein a second area of a second facing side of each of the second detector elements is larger than a first area of a first radiation facing side of each of the first detector elements.

17. The method of claim 16, wherein the second area is 1 to 4 times larger than the first area.

18. The method of claim 13, wherein the plurality of image performance metrics includes horizontal resolution, vertical resolution, an amount of penetration and wire detection.

19. The method of claim 18, further comprising:
optimizing a horizontal resolution of the dual-energy scan image by applying said function to data associated with two of the first detector elements positioned in the first plurality of distinct spaces located above and below said at least one of the first plurality of distinct spaces that does not have said active detector element.

20. The method of claim 18, further comprising:
optimizing a vertical resolution of the dual-energy scan image by applying said function to data associated with two of the first detector elements positioned in the first plurality of distinct spaces located to the right and left of said at least one of the first plurality of distinct spaces that does not have said active detector element.

21. The method of claim 18, further comprising:
optimizing a degree of penetration or wire detection in the dual-energy scan image by applying said function to data associated with four of the first detector elements positioned in the first plurality of distinct spaces located to the left, to the right, above and below said at least one of the first plurality of distinct spaces that does not have said active detector element.
